(19) United States
(12) Patent Application Publication
(10) Pub. No.: US 2014/0081710 A1
(43) Pub. Date: Mar. 20, 2014

(54) System And Method For Presenting Big Data Through A Web-Based Browser Enabed User Interface

(71) Applicant: Adam Rabie, Toronto, CA (US)

(72) Inventor: Adam Rabie, Toronto, CA (US)

(21) Appl. No.: 14/029,644

(22) Filed: Sep. 17, 2013

Related U.S. Application Data
(60) Provisional application No. 61/744,122, filed on Sep. 17, 2012.

(51) Int. Cl. G06Q 30/02

(52) U.S. Cl. CPC G06Q 30/0206
USPC 705/7.35

(57) ABSTRACT

A system for determining asset prices within a web-based application IS PROVIDED. The system includes a backend server comprising a data collection engine for collecting data from a plurality of data sources, a data standardization engine for standardizing the data collected by the data collection engine, and an Applications Programming Interface (API) engine for carrying out requests as demanded by an end user through a web-based enabled user interface; a database server comprising one or more database tables for storing the data collected from the data collection engine; and a frontend server comprising a web server that interacts with the API engine and communicates with the user interface via a web based application hosted on the web server.

### RELATED APPLICATIONS

This application claims the benefit under 35 USC §119(e) to U.S. Provisional Application No. 61/744,122, filed on Sep. 17, 2012, the contents of which are hereby incorporated by reference in their entirety.

### FIELD OF THE INVENTION

This invention relates to web browsers, and more particularly, a system and method for managing big data for presentation through a web-based browser enabled user interface.

### BACKGROUND

Until recently the world of financial data applications has been one of little accessibility. Today, however, major companies such as Yahoo™ and Google™ offer their own web-based financial systems which provide free stock quotes, and access to a breadth of market-related financial data. However, due to the infancy of the industry, and lack of innovation, the variety of data, and control over such data, available to an end user has been limited. In fact, popular financial web-based systems today are still far inferior to their software counterparts in terms of user empowerment and accessible volume of data. On the other hand, software-based financial systems have their own drawbacks: lacking affordability, accessibility over the web, and often requiring deep learning curves.

Limitations of web-based financial applications are rooted in the inability to service a large volume, variety, granularity and manipulability of data delivered to the end user in a computationally limited browser environment. Major financial websites, particularly those offering interactive charting and other visualizations, conduct significant averaging of data and limit a user's ability to calculate and manipulate the data in order to reduce processing times. This improvement in the end user's experience, allowing them to receive a result faster, comes at the cost of limiting manipulability and dissolving much of the raw data which the end user can never access even with further interaction.

The limitation of data manipulability within a browser incapacitates the end user's abilities to discover many important insights. For example, generally, quotes for financial assets are provided “as-is” with little to no ability to manipulate or interact with the data for further and deeper analysis. Pricing options, for example, in current financial data representations are virtually non-existent, as an asset's or economic variable's commonly traded or listed currency is all that is accessible. Asset repricing and pricing options are not commonly available to the end user via web-based financial applications due to the inherent computational restraints imposed on the web browser itself. The lack of manipulability of data further implies that current web-based financial applications do not provide means for graphical representations, inter-comparisons, or technical analytics on manipulated series. Web browsers, in some cases, may technically be able to perform and complete such manipulations and presentation of data without applying an optimized algorithm; however the time, memory and compute (CPU) requirements in completing the process can limit the practical usability of the web-based application.

Furthermore, web browsers and devices vary greatly as they are all built differently and therefore execute websites differently. Additionally, a web browser may have many versions, requiring web based applications to function appropriately in the varying browser environments. Furthermore, variable performance computers may run a variable version of a variable web browser. Also, many web browsers themselves restrict the total CPU and memory resources of the browser enabled user interface a website can utilize such that the website is restricted from monopolizing the system's resources. These limiting factors make it difficult to build web-based applications which are functional on various web browsers and devices, and which process large amounts of data without a sophisticated data delivery algorithm. Therefore, current applications do not allow a user to retrieve and manipulate large amounts of data due to the constraints imposed by the browsers and their limiting environments.

An example of utility of data manipulability is found in part in the aforementioned repricing capacity which is sparingly found in financial applications. Given globalization and growth of foreign investors into varying markets around the world, the need for currency effects to be factored into traditional investments is of high importance to investors and researchers. Foreigners, such as Canadians, are not able to view full United States based stock series priced in their local currency, Canadian dollars, unless individual attempts are made to convert and interpolate the series outside the primary web applications delivering the data; a time consuming and difficult task for the end user.

Similarly, web-based economic data currently available possess similar limitations. Economic watchers are unable to access, interactively via the web, measurements of the economy outside of the local currency that is initially provided. If a user is interested in America's national income in terms of gold ounces, barrels of oils, bitcoin or foreign currency, for example, the user would have to perform the analysis independent of the web-based financial system. The utility in manipulability of financial, social and economic data extends further to spread traders, custom index or metric tracking, and an innumerable amount of alternative uses with which a user might discover.

The lack of current accessibility of data manipulability at the web application arises from limitations that are due in large part to the aforementioned system's inability to retrieve, store, and manage large volumes of data within a web-browser efficiently and accurately. Web-browser based applications are limited in their ability to retrieve, process and make available large volumes of data without causing performance and usability issues for the end user. The amount of processing required to handle various requests such as high volumes of data, visualizations, asset repricing and general series manipulations is computationally intense and usually cannot be performed within the limitations of the browser and a typical personal computing device.

The person skilled in the art would appreciate that better control over data within a web-based system is advantageous. For example, converting and interpolating US based stock series or any foreign based stock series into a user's home currency within a web-based system is desirable as the performance measurement of the newly priced series will have already discounted the currency fluctuations the foreign portfolio undergoes. This provides more accurate reflections of the real performance of the user's portfolio through graphical representations of growth, stagnation and recession.

### SUMMARY OF INVENTION

The market deficiency which inspired this invention is a lack of powerful web applications for handling and presenting financial and economic data, though the present invention is applicable to any big data web application.

In one aspect the present invention provides a system for determining asset prices within a web-based application, the system comprising: a backend server comprising a data collection engine for collecting data from a plurality of data sources, a data standardization engine for standardizing the data collected by the data collection engine, and an Applications Programming Interface (API) engine for carrying out requests as demanded by an end user through a web-based enabled user interface; a database server comprising one or more database tables for storing the data collected from the data collection engine; and a frontend server comprising a web server that interacts with the API engine and communicates with the user interface via a web based application hosted on the web server.

In a further aspect of the present invention, the one or more database tables include an unprocessed standardized table, an unprocessed non-standardized table, and a processed standardized table.

In a further aspect of the present invention, the database server is a Relational Structured Query Language database server.

In a further aspect of the present invention, the user interface comprises a personal computer system or mobile device.

In a further aspect of the present invention, the data collection engine executes data retrieval scripts to collect series data from said plurality of data sources.

In a further aspect of the present invention, the series data collected comprises foreign exchange series, equities series, precious metals series, social data series, environmental data series and macroeconomic data series.

In a further aspect of the present invention, the series data collected is parsed, and fields are extracted, said fields comprising date-time and value.

In a further aspect of the present invention, the data collection engine determines if the series collected data is received in standard form or non-standard form, whereby the series collected data received in standard form is sent to the database server to be stored in the unprocessed standardized data table and whereby the series collected data received in non-standard is sent to the database server to be stored in the unprocessed non-standardized data table.

In a further aspect of the present invention, the data standardization engine runs a standardization algorithm on the unprocessed non-standard data stored in the unprocessed non-standardized data table to convert the unprocessed non-standard data into processed standardized data for storage in the processed standardized table.

In a further aspect of the present invention, the standardization algorithm comprises steps for:
a. Determining a start date, end date and interval period for standardization;
b. Identifying a series list of one or more series of unprocessed non-standard data;
c. Retrieving the one or more unprocessed non-standard data of the series list from the data table between the start date and the end date;
d. Generating an interval period list for the series list between the start date and end date;
e. Determining if each interval period contains a corresponding value from the one or more unprocessed non-standard data of the series list, whereby:
   f. if the one or more unprocessed non-standard data of the series list has fully corresponding values in each interval period, inserting the data series into the processed standardized table with only the matching period's values as processed series data; or
   g. if the one or more unprocessed non-standard data of the series list does not have fully corresponding values in each interval period, interpolating each missing value of the interval period and inserting the data series including each interpolated missing value into the processed standardized table with only the matching period's values as processed series data.

In a further aspect of the present invention, the standardized processed series data is stored in the processed standardized data table.

In a further aspect of the present invention, the API engine includes a data retrieval engine for retrieving data from the database server, and a data manipulation engine for manipulating the data retrieved from the database server based on a request requested by a user through the user interface.

In a further aspect of the present invention, the API engine is a Hypertext Transfer Protocol (HTTP) server that runs a Python-based API engine which outputs the processed data in Java Script Object Notation (JSON) form.

### BRIEF DESCRIPTION OF THE FIGURES

Reference may now be had to the following detailed description taken together with the accompanying drawings, in which:

FIG. 1 illustrates a schematic overview of a system in accordance with an embodiment of the present invention;

FIG. 2 illustrates a schematic overview of the user interface of the system shown in FIG. 1;

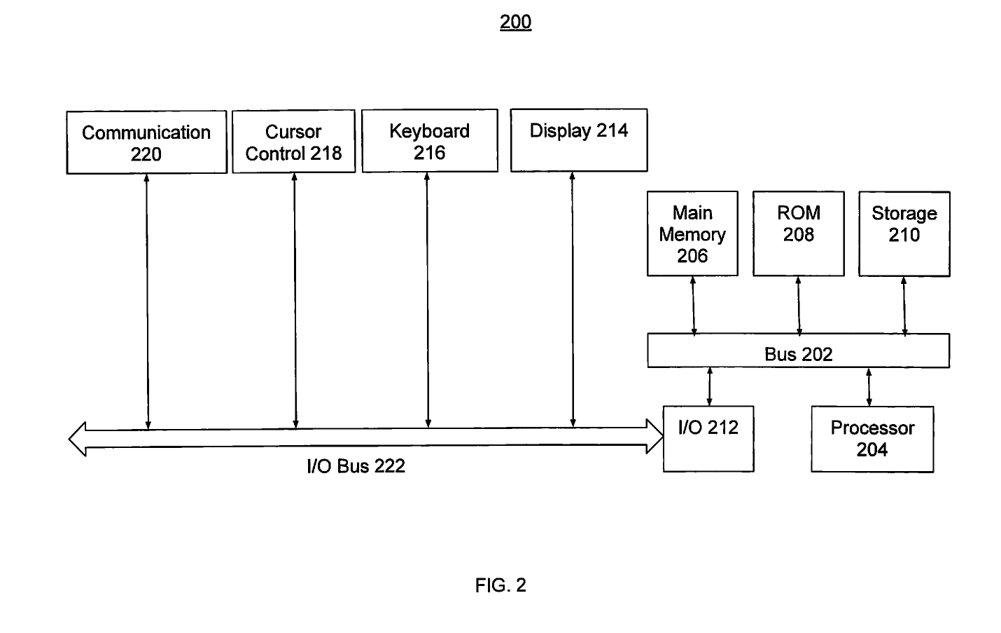

FIG. 3 illustrates a schematic overview of the data collection engine of the system shown in FIG. 1;

FIG. 4 illustrates a schematic overview of the API engine of the system shown in FIG. 1;

FIG. 5 illustrates a schematic overview of the data retrieval engine of the API engine shown in FIG. 4;

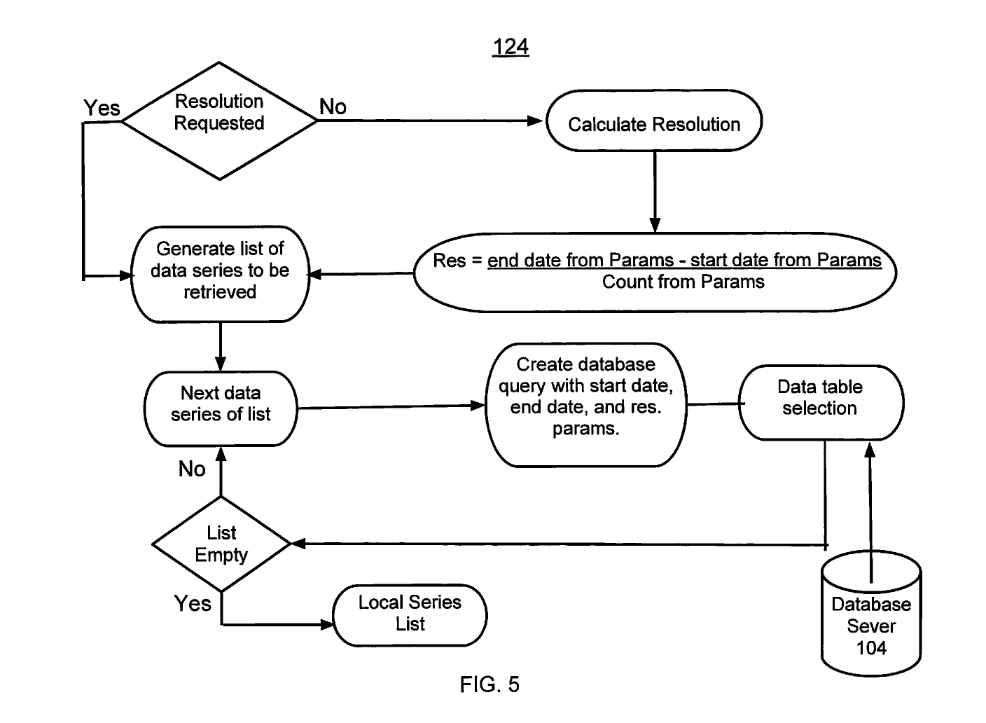

FIG. 6 illustrates a schematic overview of the data manipulation engine of the API engine of the API engine shown in FIG. 4; and

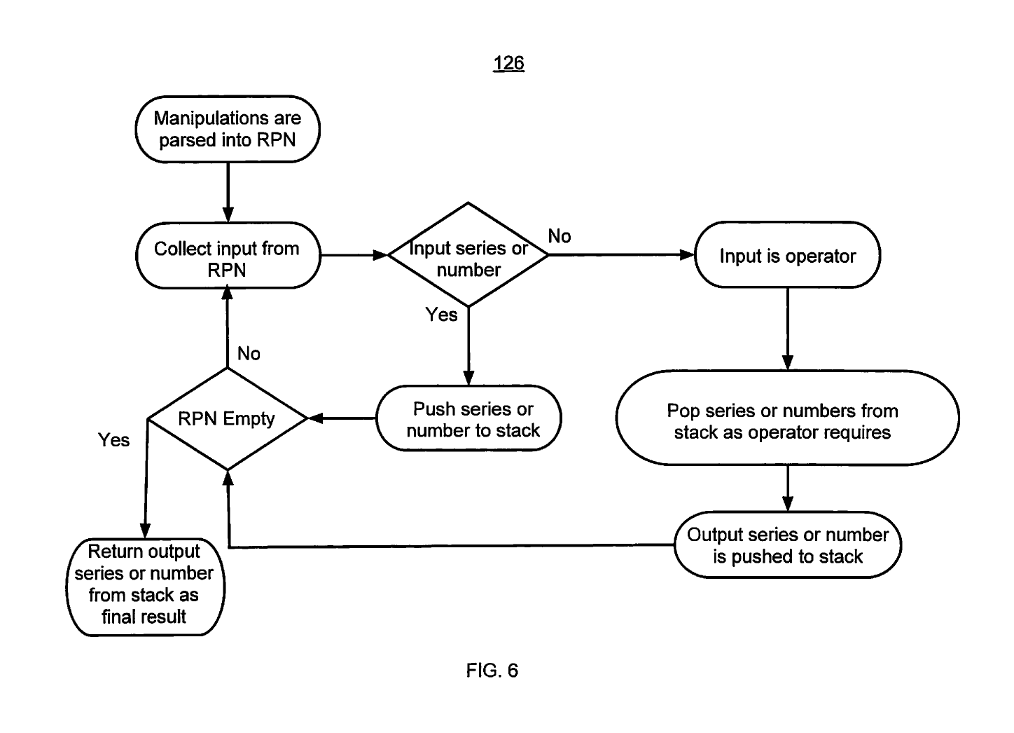

FIG. 7 illustrates a schematic overview of a web-based application in accordance with an embodiment of the present invention.

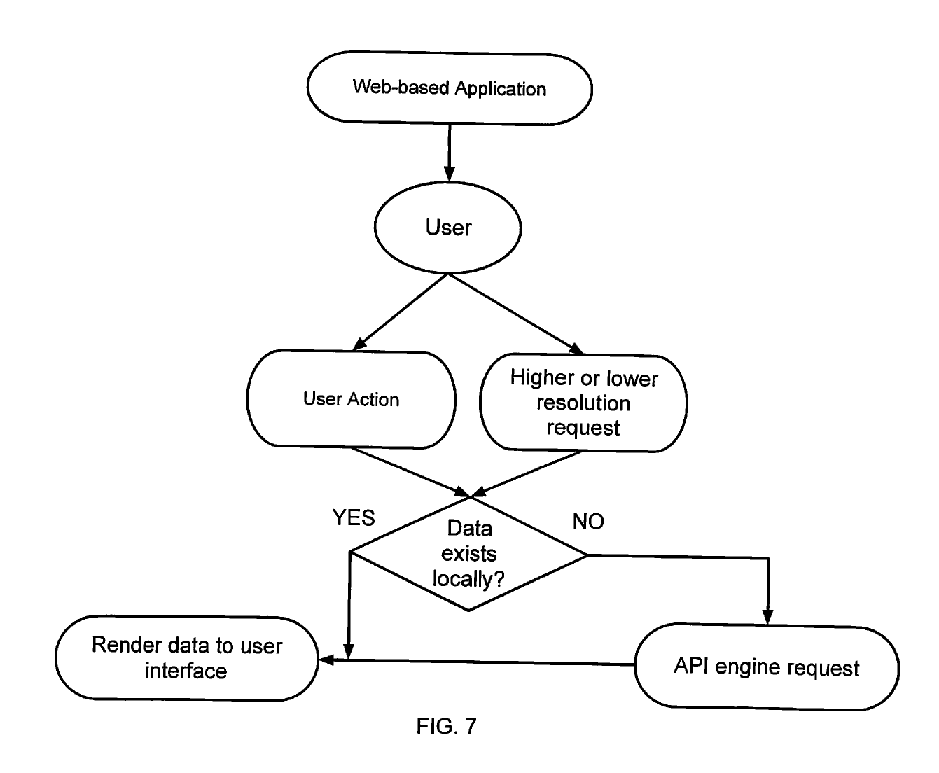

### DETAILED DESCRIPTION OF THE PREFERRED EMBODIMENT

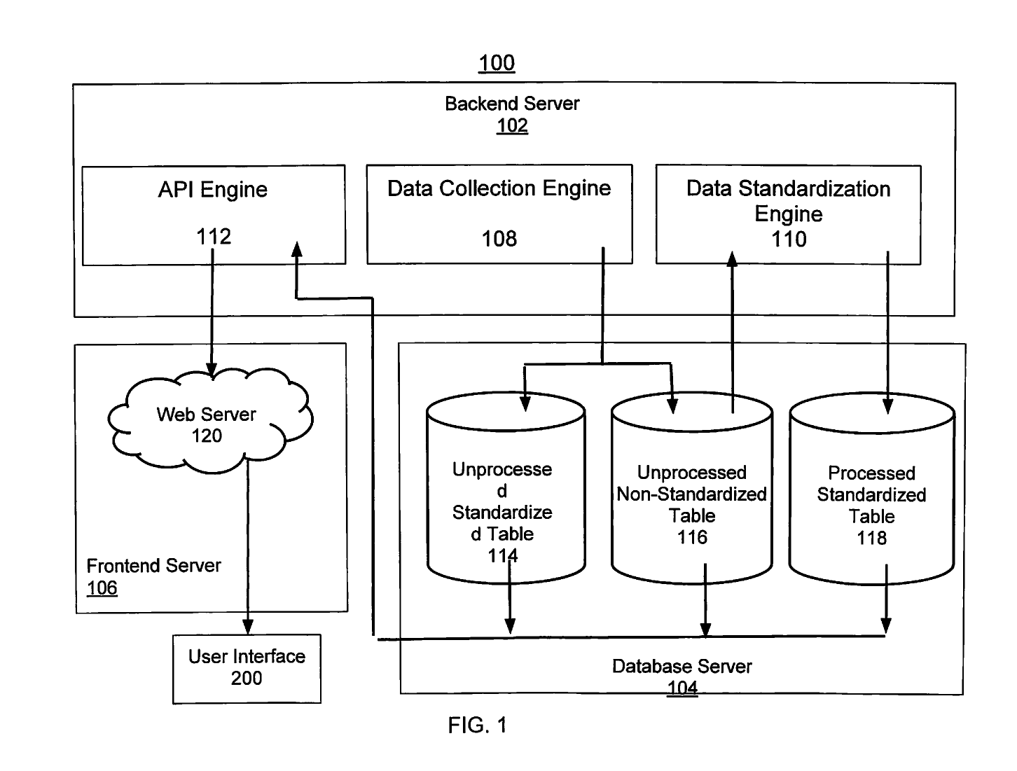

FIG. 1 illustrates schematically a system 100 in accordance with a preferred embodiment of the present invention. The system 100 includes a backend server 102, a database server 104, and frontend server 106.

The backend server 102 includes a data collection engine 108 for collecting data from a plurality of data sources, a data standardization engine 110 for standardizing the data collected by the data collection engine 108, and an Applications Programming Interface (API) engine 112 for carrying out various requests as demanded by an end user through a web-based enabled user interface 200.

The database server 104 is a Relational Structured Query Language (SQL) database server. Other database technologies as known in the art may be implemented, and may vary performance accordingly. The database server 104 includes one or more database tables for storing the data collected from the data collection engine 108, or data that is manually inputted into the one or more database tables. Preferably, the one or more database tables include an unprocessed standardized table 114, an unprocessed non-standardized table 116, and a processed standardized table 118.

The frontend server 106 includes a web server 120 that interacts with the API engine 112 and communicates with the user interface 200 via a web based application hosted on the web server 120.

The user interface 200 may be a personal computer system, a mobile device, or the like which has web browsing capabilities. The user interface 200 may include a system bus 202 for communicating information, and a processor 204 coupled to the bus 202 for processing information. The user interface 200 may further comprise a random access memory 206 (RAM) or other dynamic storage device (referred to herein as main memory), coupled to the bus 202 for storing information and instructions to be executed by the processor 204. Main memory 206 may also be used for storing temporary variables or other intermediate information during execution of instructions by the processor 204. The user interface 200 may also include a read only memory 208 (ROM) and/or other static storage device coupled to the bus 202 for storing static information and instructions used by the processor 204.

A data storage device 210 such as a magnetic disk or optical disc and its corresponding drive may also be coupled to the user interface 200 for storing information and instructions. The user interface 200 may also be coupled to a second I/O interface 212. A plurality of I/O devices may be coupled to the I/O bus 222, including a display device 214, an input device (e.g., an alphanumeric input device 216 and/or a cursor control device 218), and the like. A communication device 220 is provided for communicating with the web server 120. The communication device 220 may comprise a modem, a network interface card, or other well-known interface devices for connectivity to the web server 120.

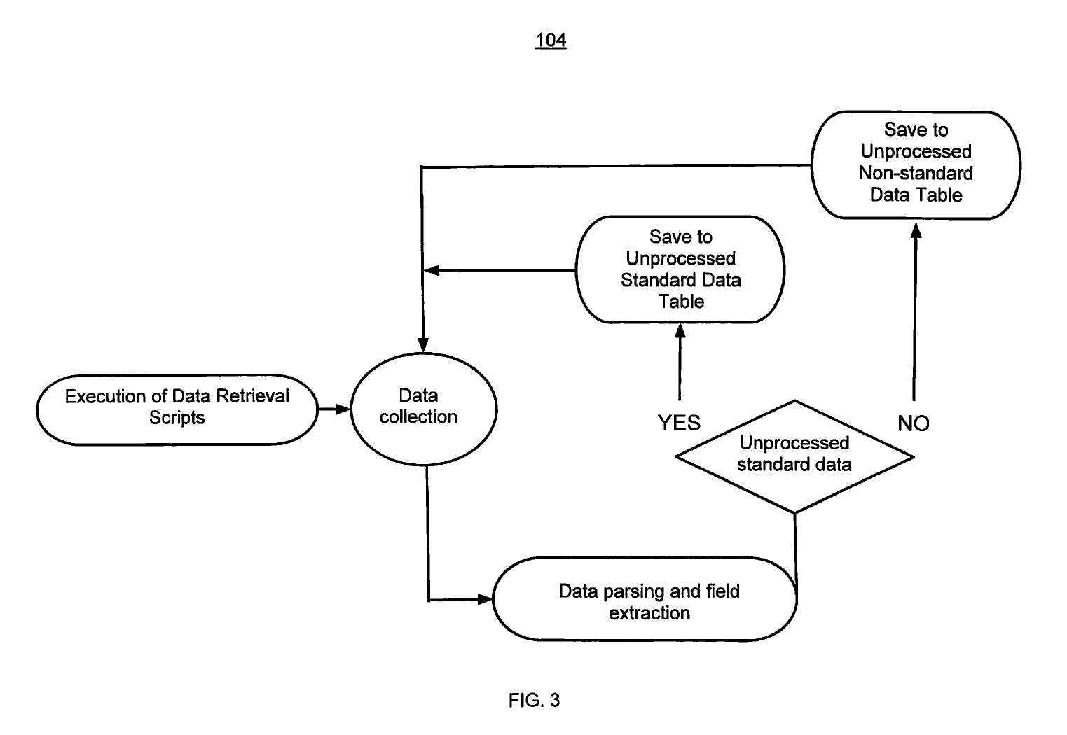

Referring now to FIG. 3, the data collection engine 108 is powered by data retrieval scripts. These scripts are run on the backend server 102. When the scripts are executed, data is collected from the plurality of data sources. The size, type and volume of data series collected depend on the script. Non-limiting examples of the types of the data series collected may include foreign exchange, equities, precious metals, social data, environmental data and macroeconomic data.

The collected data is parsed, and fields are extracted, as for example date-time, and value. The data collection engine 108 determines if the collected data is received in standard form where each data point/value is collected at equal time intervals/periods, as for example historical data as a form of standardized data, or non-standard form where each data point/value is not collected at equal time intervals/periods, as for example real-time data as a form of non-standardized data.

If the data collection engine 108 determines that the collected data is in a standard form, the data collected is sent to the database server 104 to be stored in the unprocessed standardized data table 114. If the data collection engine 108 determines that the data collected is in a non-standard form, the data collected is sent to the database server 104 to be stored in the unprocessed non-standardized data table 116.

The data standardization engine 110 of the backend server 102 runs a standardization algorithm on the unprocessed non-standard data stored in the unprocessed non-standardized data table 116 to convert the unprocessed non-standard data into processed standardized data for storage in the processed standardized table 118. Standardizing unprocessed non-standard data on the backend server 102 allows for computationally sound and faster cross comparisons between differing data series when requested by the user of the user interface 200. The unprocessed non-standardized data may also be used for output purposes, but computations or cross-comparisons between the unprocessed non-standardized data stored in the data table 116 and other series may not be possible without a standardization technique. Accuracy and quality of the standardized data is in part dependent on the standardization technique used.

Preferably, a standardization algorithm applicable in the present invention is as follows:
a. A start date, end date and interval period for standardization is determined;
b. A series list identifying one or more series of unprocessed non-standard data is retrieved from the unprocessed non-standardized data table 116 of the database server 104;
c. The one or more unprocessed non-standard data of the series list is retrieved from the data table 116 between the start date and the end date;
d. An interval period list between the start date and end date is generated for the series list;
e. The data standardization engine 110 determines if each interval period contains a corresponding value from the one or more unprocessed non-standard data of the series list.
   f. If the one or more unprocessed non-standard data of the series list has fully corresponding values in each interval period, then the data series is inserted into the processed standardized table 118 with only the matching period's values.
   g. If the one or more unprocessed non-standard data of the series list does not have fully corresponding values in each interval period, then the data standardization engine 110 interpolates each missing value of the interval period and the data series is then inserted into the processed standardized table 118 with only the matching period's values.

After standardizing the data stored in the data table 116, the newly processed data is inserted and stored in the processed standardized data table 118. The API engine 112 may now perform manipulations and computations as requested by the user through the user interface 200 as more fully detailed below.

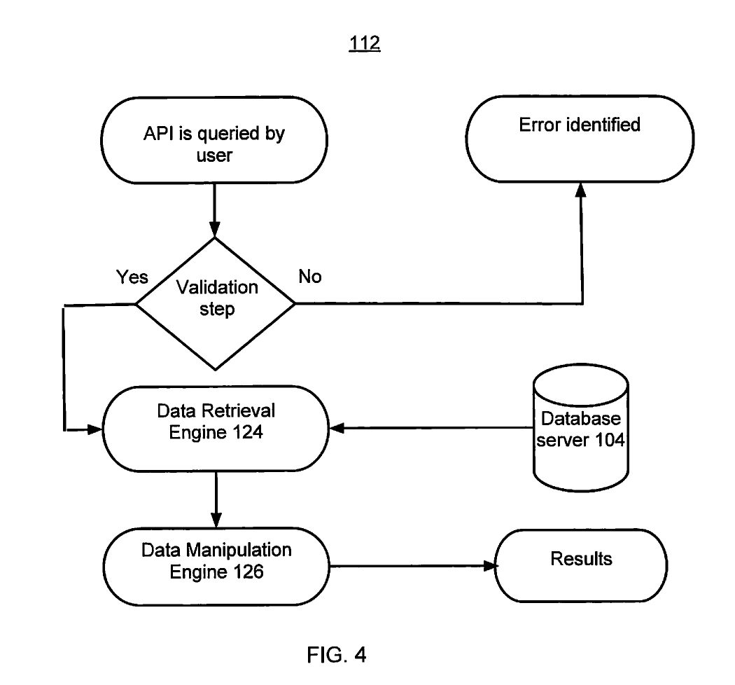

FIG. 4 shows an overview of the process performed by the API engine 112. The API engine 112 includes a data retrieval engine 124 for retrieving data from the database server 110, and a data manipulation engine 126 for manipulating the data retrieved from the database server 110.

The API engine 112 preferably is a Hypertext Transfer Protocol (HTTP) server that runs a Python-based API engine which outputs the processed data in Java Script Object Notation (JSON) form. The engine 112 allows for a large number of manipulations to be performed on the data stored in the database server 104 within the API engine 112, as for example, mathematical, statistical and other custom manipulations. Other API engine formats as known in the art may be implemented in accordance with the present invention.

In operation, a user enters a request through the web-based application 300. The user request may be inputted by the user through the alphanumeric input device 216 and/or the cursor control device 218 or any similar manner known in the art. Preferably, the user request may be entered using a single step or action, such as one-click action, cell input or predetermined drop-down menu selections. The user may also request through the web application higher or lower resolutions, thereby allowing full access to the breadth of data available in the database server 104. The web-based application determines if the data series needed to complete the user request exist locally within the web-based application or if the series is to be retrieved from the database server 104. The series may exist locally in the web-application if a similar user request was previously made and the results were previously saved locally within the web-application. If the series exists locally, the user request is returned and the results displayed on the display device 214 of the user interface 122. If the series does not exist locally, or a new series/manipulations is needed, the web-based application determines the necessary API engine query parameters to complete the request. The web-based application communicates with the web server 120 through the communication device 220 of the user interface 200 and the web server 120 in turn queries the API engine 112 using the API engine query parameters. The API engine query parameters may include a specific series or multiple series of data, manipulations, a date range, etc.

The API engine 112 first validates the API engine query parameters in a validation step. If the user request includes invalid API engine query parameters, then an error message is displayed to the user on the display device 214 of the user interface 200. The user may then amend the API engine query parameters until they are accepted by the API engine 112.

If the API engine query parameters are valid, the data retrieval engine 124 of the API engine 112 determines the required data to be retrieved from the database server 104 based on the request, and delivers the data to the data manipulation engine 126 of the API engine 112. The data manipulation engine 126 processes the data retrieved from the database server 104 and carries out the user request. The results determined by the data manipulation engine 126 are returned and displayed on the display device 214 of the user interface 200 through the web server 120 via the web application, and may be stored locally within the web-application 300.

The functions of the data retrieval engine 124 and the data manipulation engine 126 are more detailed below.

The data retrieval engine 124 first determines if a resolution request exists in the API engine query parameters. If a resolution is not found, the data retrieval engine 124 calculates the resolution. Preferably, the resolution is calculated using a count API engine query parameter as follows:

$$Resolution = \frac{\begin{matrix}end date from request parameters - \\ start date from request parameters\end{matrix}}{count from request parameters}$$

If a resolution request is found or if a resolution is calculated using the count parameter, the data retrieval engine 124 then determines the required data series to be retrieved from the database server 104 needed to complete the user request, and generates a list of one or more data series to be retrieved.

A database query is generated by the data retrieval engine 124 to retrieve the required data from the data tables 114, 116, 118 of the database server 104 to fill the data of the one or more data series of the list generated.

The data retrieval engine 124 creates and performs the database query starting with a first of the data series of the one or more data series of the list. The database query contains the series, a start date, an end date, and the resolution parameters calculated or requested. The data retrieval engine 124 selects which data table 114, 116, 118 stored on the database server 104 the data of the first data series is to be retrieved from. Once the data of the first data series of the list is retrieved, the data retrieval engine 124 stores the data locally within the API engine 112. The data retrieval engine 124 then similarly fills the data of a next data series of the one or more data series of the list until all of the data of the one or more data series is retrieved and stored locally within the API engine 112 as a local series list. Like the data series of the list, the next data series of the one or more data series list may be retrieved from any one of the data tables 114, 116, 118 stored on the database server 104.

The process continues until the data retrieval engine 124 determines that there is no data of the one or more data series of the list left to be retrieved. The data retrieval engine 124 delivers the fully populated local series list, and requested manipulations to the data manipulation engine 126.

The data manipulation engine 126 performs the desired manipulations, calculations, processes or the like on the local series list stored within the API engine 112. The requested manipulations and/or calculations are parsed into a Reverse Polish Notation (RPN) expression. It is to be understood that other mathematical formats may be used, as for example Infix, and Polish. An input is collected from the RPN expression. The manipulation engine 126 then determines if the input is a series, number, or operator. If the input is a series or a number, the input is pushed on a stack. If the input is not a series or a number, then the input is determined to be an operator. The manipulation engine 126 then pops as many series or numbers from the stack as the operator requires. The popped series or numbers are manipulated by looping through the series or numbers and applying the operations. The output is a series or number that is then pushed to the stack. After the series or number is pushed onto the stack, the data manipulation engine 126 determines if the RPN expression is empty. If the RPN expression is not empty, the next input from the RPN expression is collected, and the process is repeated until the data manipulation engine 126 determines that the RPN expression is empty. If the RPN expression is empty, the data manipulation engine 126 returns output series or number from the stack as a final result. The final result is returned to the web-based application in JSON format and displayed on the display device 214 of the user interface 200 through the web server 120 via the web-based application, and may be stored locally within the web-based application for use in a subsequent request. It is to be understood that other formats may be used, as for example XML or CSV.

Although this disclosure has described and illustrated certain preferred embodiments of the invention, it is also to be understood that the invention is not restricted to these particular embodiments rather, the invention includes all embodiments which are functional, or mechanical equivalents of the specific embodiments and features that have been described and illustrated herein. Furthermore, the various features and embodiments of the invention may be combined or used in conjunction with other features and embodiments of the invention as described and illustrated herein. The scope of the claims should not be limited to the preferred embodiments set forth in the examples, but should be given the broadest interpretation consistent with the description as a whole.

The embodiments of the invention in which an exclusive property or privilege is claimed is defined as follows:

1. A system for determining asset prices within a web-based application, the system comprising:
a backend server comprising a data collection engine for collecting data from a plurality of data sources, a data standardization engine for standardizing the data collected by the data collection engine, and an Applications Programming Interface (API) engine for carrying out requests as demanded by an end user through a web-based enabled user interface;
a database server comprising one or more database tables for storing the data collected from the data collection engine; and
a frontend server comprising a web server that interacts with the API engine and communicates with the user interface via a web based application hosted on the web server.

2. The system according to claim 1, wherein the one or more database tables include an unprocessed standardized table, an unprocessed non-standardized table, and a processed standardized table.

3. The system according to claim 2, wherein the database server is a Relational Structured Query Language database server.

4. The system according to claim 3, wherein the user interface comprises a personal computer system or mobile device.

5. The system according to claim 4, wherein the data collection engine executes data retrieval scripts to collect series data from said plurality of data sources.

6. The system according to claim 5, wherein the series data collected comprises foreign exchange series, equities series, precious metals series, social data series, environmental data series and macroeconomic data series.

7. The system according to claim 6, wherein the series data collected is parsed, and fields are extracted, said fields comprising date-time and value.

8. The system according to claim 7, wherein the data collection engine determines if the series collected data is received in standard form or non-standard form, whereby the series collected data received in standard form is sent to the database server to be stored in the unprocessed standardized data table and whereby the series collected data received in non-standard is sent to the database server to be stored in the unprocessed non-standardized data table.

9. The system according to claim 8, wherein the data standardization engine runs a standardization algorithm on the unprocessed non-standard data stored in the unprocessed non-standardized data table to convert the unprocessed non-standard data into processed standardized data for storage in the processed standardized table.

10. The system according to claim 9, wherein the standardization algorithm comprises steps for:
a. Determining a start date, end date and interval period for standardization;
b. Identifying a series list of one or more series of unprocessed non-standard data;
c. Retrieving the one or more unprocessed non-standard data of the series list from the data table between the start date and the end date;
d. Generating an interval period list for the series list between the start date and end date;
e. Determining if each interval period contains a corresponding value from the one or more unprocessed non-standard data of the series list, whereby:
f. if the one or more unprocessed non-standard data of the series list has fully corresponding values in each interval period, inserting the data series into the processed standardized table with only the matching period's values as processed series data; or
g. if the one or more unprocessed non-standard data of the series list does not have fully corresponding values in each interval period, interpolating each missing value of the interval period and inserting the data series including each interpolated missing value into the processed standardized table with only the matching period's values as processed series data.

11. The system according to claim 10, wherein the standardized processed series data is stored in the processed standardized data table.

12. The system according to claim 11, wherein the API engine includes a data retrieval engine for retrieving data from the database server, and a data manipulation engine for manipulating the data retrieved from the database server based on a request requested by a user through the user interface.

13. The system according to claim 12, wherein the API engine is a Hypertext Transfer Protocol (HTTP) server that runs a Python-based API engine which outputs the processed data in Java Script Object Notation (JSON) form.
